(19) United States
(12) Patent Application Publication
(10) Pub. No.: US 2022/0312801 A1
(43) Pub. Date: Oct. 6, 2022

(54) EDIBLE FILM AND RELATED USES

(71) Applicant: JUMPSTAR10 S.R.L., Parma (PR) (IT)

(72) Inventors: Giorgio Pelosi, Parma (IT); Franco Bisceglie, Parma (IT); Cristina Bacci, Sant'Ilario D'Enza (RE) (IT)

(73) Assignee: JUMPSTAR10 S.R.L., Parma (PR) (IT)

(21) Appl. No.: 16/958,002

(22) PCT Filed: Dec. 27, 2018
(86) PCT No.: PCT/IB2018/060636

§ 371 Date: Jun. 25, 2020

(30) Foreign Application Priority Data
Dec. 29, 2017 (IT) 102017000150824

(51) Int. Cl. A23L 3/3472; A23L 29/256; A23L 29/238

(52) U.S. Cl. CPC A23L 3/3472; A23L 29/256; A23L 29/238

(57) ABSTRACT

The present invention concerns a composition based on a mucous secretion of gastropods, preferably snail slime. In addition, this invention concerns a film or edible film obtained/obtainable with this composition and its use in the food industry, preferably to conserve, preserve or store food.

### FIELD OF INVENTION

The present invention concerns a composition based on a mucous secretion of gastropods, preferably snail slime. Furthermore, the present invention concerns an edible film obtained/obtainable from this composition and its use in the food sector, preferably to preserve, preserve or store food.

### STATE OF THE ART

During storage and distribution, food is exposed to a large number of factors that can change its intrinsic properties and oxygen, light and moisture are among the possible degradation agents. It is in this context that the concept of “shelf-life” becomes crucial, defined as the time interval during which the food maintains an acceptable level of safety and quality and therefore, the period of time that corresponds, under certain storage conditions, to a tolerable decrease in the quality of a food.

The shelf-life often intertwines with another concept that is the marketability of a product. In fact, the establishment of processes that modify the food can make it no longer marketable despite this is still edible, resulting in a significant increase in business costs.

In addition to determining shelf-life, manufacturers are often faced with the need to make their products more stable in order to cope with distribution chains that require a longer and longer shelf-life or, simply, to be able to better preserve the quality of their product. Foods that are “very perishable from a microbiological point of view”, where the expiry date is used, are products that normally have to be kept in the refrigerator, such as fresh cheese, meat and some meat based products, fresh pasta, refrigerated ready meals, fruits and vegetables of the IV range, etc..

The technologies used to improve the preservation, and therefore the shelf-life of the food, are based essentially either on the ability to limit microbial growth (bacteriostatic effect) or on the definitive inactivation of the associated flora (bactericidal effect). The first group includes, for example, refrigeration or freezing, drying, vacuum storage or the use of a modified atmosphere, the addition of acids to stimulate fermentation, the use of organic or inorganic preservatives. Technologies such as pasteurization, irradiation with ionizing radiation, the application of high hydrostatic pressures (HPP), the use of high voltage electric charges or the addition of lysozyme instead determine a bactericidal effect.

Nowadays there is a greater tendency on the part of consumers to prefer products without artificial preservatives and this has led the food industry to develop technologies that act with “more natural” approaches. Among these we certainly find the irradiation or the application of high hydrostatic pressures. All these new generation technologies act in a definitive way on the microbial load associated with treated foods.

However, not all food products can be subjected to the above treatments; for example, HPP cannot be used on fresh meat (as it causes a “bleaching” that is unpleasant for the consumer) or on spongy foods such as strawberries. The need to identify natural substances or to develop new technologies to be applied to the food sector is becoming increasingly pressing on the part of industry.

Because of their intrinsic properties, these foods are an easy growing ground for micro-organisms: in a short time signs of alteration progressively appear accompanied by increasing levels of micro-organisms, until they become unacceptable for consumption or unsafe.

For this reason, it is considered that, after the expiry date, these products constitute an objective risk to the health of the consumer, even in the absence of organoleptically evident changes. In these cases there is a shelf-life that is measured in days or weeks.

In this regard, the Applicant has surprisingly found that a composition based on snail slime, is able to increase the shelf-life of foods while preserving the original organoleptic characteristics of the food.

### SUMMARY OF THE INVENTION

The present invention concerns a composition comprising at least one mucous secretion of gastropods, preferably snail slime and at least one additional ingredient chosen from: a gelling agent, a plasticizing agent, a crosslinking agent and eventually a crosslinking adjuvant wherein said mucous secretion, preferably snail slime, is present in a concentration as a dry residue in a percentage (%) comprised between 0.8 and 2% w/w of the weight of the total mass of the composition.

Preferably said gelling agent is chosen from: alginates, propylene glycol, pectin, and natural gelling agents such as agar agar, carboxymethylcellulose, methylcellulose, hydroxypropyl methylcellulose, guar gum, carob gum, xanthan gums, hydrolysed gums, carrageenan, tamarind, konjac, arabinogalactan, arabinogalactan from larch, beta-glucan, levan, pullulan, curd, chitosan, gum arabic, native starches such as maize starch, waxy maize starch, potatoes, tapioca, rice and wheat starch, modified starches, maltodextrins, albumin, gelatin, casein, casein salts, whey, wheat gluten, zein, soy protein, polyvinylpyrrolidone, methacrylate copolymers and carboxyl-vinyl copolymers alone and their combinations; said agent being present in a concentration preferably between 0.2 and 3% w/v of the solution, more preferably between 0.5 and 2% w/v, even more preferably between 0.8 and 1.3% w/v.

Preferably said plasticizing agent is chosen from: glycerol, hydrogenated and partially hydrogenated vegetable oil, cocoa butter, sorbitol and other polyols, glycerine, polyethylene glycol, propylene glycol, inverted sugars, corn syrup, lecithin, hydrogenated lecithin, mono-, di- and triglycerides, acetylated monoglycerides, stearic, palmitic, oleic and linoleic acids and their combinations; said plasticizer being present in a concentration preferably between 20 and 60% w/w compared to the weight of the gelling agent.

Preferably said crosslinking agent is chosen from: calcium carbonate, calcium chloride, calcium citrate, calcium gluconate, calcium phosphate, tri-calcium phosphate, calcium sulphate, microcrystalline cellulose, cellulose polymers, magnesium, ground limestone, silicates, clay, talc, titanium dioxide, monocalcium phosphate, others as mass fillers and their combinations; said crosslinker being present in a concentration preferably between 8-10% w/w compared to the weight of the gelling agent.

Preferably the snail slime is characterized by:
a pH comprised between 2 and 4, preferably between 2.5 and 2.9; and/or
a dry residue of more than or equal to 3%; and/or
a density greater than 1.01 g/cm³; and/or
a good antioxidant power.

In addition, snail slime preferably includes:
glycolic acid, preferably in quantities ranging from 50 mg/kg to 200 mg/kg; and/or
allantoin, preferably in quantities ranging from 50 mg/kg to 200 mg/kg; and/or
antimicroprotease, preferably in quantities ranging from 1.0 mU/L to 1.8 mU/L; and/or
hydroxyproline, preferably in quantities ranging from 0.5% w/w to 1.5% w/w; and/or
collagen, preferably in quantities ranging from 0.05% to 0.5% w/w;
lactic acid, preferably in a quantity varying from 10 mg/kg to 100 mg/kg; and/or
mucopolysaccharides, preferably sulphurised GAGs and/or non-sulphurised GAGs; and/or
at least one vitamin chosen from: vitamins A, C, E, B1 and B6; and/or
free amino acids.

Preferably the composition includes a crosslinking adjuvant, preferably the adjuvant is chosen from: δ-D-gluconolactone, adipic acid, citric acid, gluconic acetic acid, tartaric acid, succinic acid, lactic acid and malic acid, where the adjuvant is present in a concentration preferably between 0-60% w/w compared to the weight of the gelling agent.

The composition is preferably formulated as a film said film, being characterized preferably by at least one layer of a thickness of about 50-75 μm, preferably 60-70 μm.

The composition, preferably formulated as a film, is utilized in the food sector, preferably for the conservation, preservation or storage of the foods said foods being preferably characterized by an average life (shelf-life) of few days, preferably of 2 or 3 days, said foods being chosen between: vegetables, fruits, bakery products, fresh pasta, refrigerated ready meals, fresh cheeses, fish, meat and their derivatives.

### DETAILED DESCRIPTION OF THE INVENTION

The present invention concerns a composition comprising at least a mucous secretion (produced) of gastropods, preferably the mucous secretion of snails or snail slime, and at least one additional ingredient preferably chosen from: a gelling agent, a plasticizing agent, a crosslinker agent.

In this context, “gastropod-produced mucosal secretion” means a generally viscous substance secreted/produced/extracted/insulated by a gastropod.

Preferably said gastropod is chosen from: Helix aspersa, Helix pomatia, Otala lactea, Iberus alonensis, Cepaea nemoralis, Cepaea hortensis, C. hortensis, C. nemoralis, Otala punctata, Eobania vermiculata, Helix lucorum, Helix adanensis, Helix aperta, Theba pisana, Sphincterochila candidissima, Leucochroa candidisima, Achatina fulica and other species of the genus Achatina.

In the case of snail's mucous secretion, commonly known as “snail's slime or snail's mucous secretion” it is a secretion produced by particular glands located at the level of the snail's foot that the animal uses for different purposes such as a lubricant, as a moisturizer or protective agent, or even to facilitate adhesion to surfaces.

In this context, snails intended are preferably the most common type of snail in heliciculture (snail farming), i.e. Helix aspersa Müller. In any case, any species of snail can be used in this context.

Slime is generally a clear or barely opalescent liquid composed of synthesised products/molecules and various types of secretory glands, e.g. mucous, protein and salivary glands. In particular, snail slime includes, in addition to water, a large quantity of mucopolysaccharides preferably, sulphurised GAGs and/or non-sulphurised GAGs, which are the molecules responsible for the properties of the slime. Preferably for the purposes of this invention the slime is characterized by:

1) a pH comprised between 2 and 4, preferably between 2.5 and 2.9; and/or

2) a dry residue of more than or equal to 3%; and/or

3) a density greater than 1.01 g/cm³; and/or

4) a good antioxidant power.

Preferably said antioxidant power is measured by DPPH assay and preferably about 1 mL of mucosal secretion inhibits at least about 9 mL of 6.0×10-5M solution of DPPH-, 2,2-diphenyl-1-picrylhydrazyl, for a time of about minute. Alternatively, the antioxidant activity of the mucosal secretion used is comparable to that exerted by 1 mL of 30 mM solution of ascorbic acid on the 9 mL of 6.0×10-5M solution of DPPH, which is equivalent to saying that the percentage of inhibition of DPPH, compared to that exerted by the 30 mM solution of ascorbic acid, is about 100%.

This test allows to evaluate the ability of the compound under analysis to destroy the stable radical DPPH- and allows to determine the antioxidant power by reacting the sample to be analyzed with a solution of DPPH- and analyzing under UV-Vis rays the decrease of the peak absorption at a wavelength of 517 nm of the radical DPPH-. The decrease of the absorbance intensity is proportional to the antioxidant capacity of the molecule/substance tested; that is, given the absorbance of the DPPH at λ of 517 nm as a function of its concentration according to the relation A=εcd (known as Lambert-Beer's law), the solution under examination reacts with the DPPH and transforms it into a colourless species, reducing its absorbance (A). Antioxidant compounds (AOH) that are capable of transferring a hydrogen atom to the DPPH radical cause the solution to discolour.

The main components of the mucous secretion of the present invention, preferably snail slime, preferably Helix aspersa are chosen from:
glycolic acid, preferably in quantities ranging from 50 mg/kg to 200 mg/kg; and/or
allantoin, preferably in quantities ranging from 50 mg/kg to 200 mg/kg; and/or
antiprotease, preferably in quantities ranging from 1.0 mU/L to 1.8 mU/L; and/or
hydroxyproline, preferably in a quantity varying from 0.5% w/w to 1.5% w/w (percentage understood as the mass of hydroxyproline over the mass of slime from Helix aspersa, e.g. 0.5 g of hydroxyproline over 100 g of snail slime); and/or
collagen, preferably in a quantity varying from 0.05% to 0.5% w/w (percentage intended as mass of collagen on mass of slime from Helix aspersa, for example 0.05 g of collagen on 100 g of snail slime);
lactic acid, preferably in quantities ranging from 10 mg/kg to 100 mg/kg; and/or
mucopolysaccharides, preferably sulphurised GAGs and/or non-sulphurised GAGs; and/or
at least one vitamin chosen from: vitamins A, C, E, B1 and B6; and/or
free amino acids.

The slime may be non-natural, i.e. synthetically produced.

In general, the mucous secretion as defined and described above, preferably snail slime, is preferably present in the composition in a concentration of dry residue in percentage (%) between 0.8 and 2% w/w of the weight of the total mass of the composition.

According to a preferred aspect of the invention, this ingredient is a gelling agent, preferably chosen from: alginates, propylene glycol, pectin, and natural gelling agents such as agar agar, carboxymethylcellulose, methylcellulose, hydroxypropyl methylcellulose, guar gum, carob gum, xanthan gums, hydrolysed gums, carrageenan, tamarind, konjac, arabinogalactan, arabinogalactan from larch, beta-glucan, levan, pullulan, curd, chitosan, gum arabic, native starches such as maize starch, waxy maize starch, potatoes, tapioca, rice and wheat starch, modified starches, maltodextrins, albumin, gelatin, casein, casein salts, whey, wheat gluten, zein, soy protein, polyvinylpyrrolidone, methacrylate copolymers and carboxyl-vinyl copolymers alone and their combinations.

Preferably said gelling agent is sodium alginate.

Preferably this gelling agent is present in a concentration between 0.2 and 3% w/v of the solution, preferably between 0.5 and 2% w/v, even more preferably between 0.8 and 1.3% w/v.

In a form of realization of the invention, said plasticizing agent is chosen from: glycerol, hydrogenated and partially hydrogenated vegetable oil, cocoa butter, sorbitol and other polyols, glycerin, polyethylene glycols, propylene glycols, inverted sugars, corn syrup, lecithin, hydrogenated lecithin, mono-, di- and triglycerides, acetylated monoglycerides, stearic, palmitic, oleic and linoleic acids and their combinations.

Preferably this plasticizing agent is present in a concentration between 20 and 60% w/w compared to the weight of the gelling agent.

In a further form of realization of the invention, said crosslinker agent is chosen from: calcium carbonate, calcium chloride, calcium citrate, calcium gluconate, calcium phosphate, tri-calcium phosphate, calcium sulphate, microcrystalline cellulose, cellulose polymers, magnesium, ground limestone, silicates, clay, talc, titanium dioxide, monocalcium phosphate, others as mass fillers and their combinations.

Preferably this crosslinker is present in a concentration between 8-10% w/w compared to the weight of the gelling agent.

Preferably this composition also includes a crosslinking adjuvant which is preferably chosen from: δ-D-gluconolactone, adipic acid, citric acid, gluconic acetic acid, tartaric acid, succinic acid, lactic acid and malic acid.

Preferably said adjuvant is present in a concentration between 0-60% w/w compared to the weight of the gelling agent.

The mucous secretion as defined and described above, preferably snail slime, is preferably present in the composition in a concentration of dry residue in percentage (%) between 0.8 and 2% w/w of the weight of the total mass of the snail slime. Where appropriate, the composition may include one or more further extracts, preferably dried, of natural origin and/or oilseeds.

Preferably said one or more extracts, preferably dry, of natural origin and/or oleolites, are present in concentrations between 50 and 150% of the value of dry residue of said mucous secretion. According to a further form of realization, the composition of the present invention, preferably for the purposes of formulation as a film, includes (average percentage composition):

1) a mucous secretion of a gastropod as defined above, preferably snail slime, 0.5-1%, preferably approximately 0.8%; and

2) a gelling agent, preferably as described above, more preferably an alginate, preferably a sodium alginate, or a pectin or agar, preferably said the gelling agent being present in a concentration varying from 45 to 50%, preferably about 49.6%; and/or

3) a plasticizing agent, preferably as described above, more preferably glycerol and/or PEG, preferably said plasticizing agent as it is present in a concentration varying from 20 to 30%, preferably about 24.8%; and/or

4) a crosslinking agent, preferably as described above, more preferably a source of Ca²⁺ ions such as calcium carbonate, and eventually an adjuvant as described above, preferably said crosslinking agent being present in a percentage between 2.5 and 7.5%, preferably about 5.0%; and/or said adjuvant being present in a concentration ranging from 15 to 25%, preferably about 19.8%. The composition of this invention may also include one or more emulsifying agents, and/or pH stabilizers, and/or preservatives, and/or surfactants and/or other ingredients known to the expert technician in the field.

In a form of embodiment, the composition further includes a colouring agent preferably natural food colouring agents or colouring agents suitable for food, pharmaceutical and cosmetic applications. These coloring agents are used in a suitable quantity to produce a desired color, or colored stripes and/or other related patterns or shapes to produce color contrasts.

According to a further form of realization of the invention, this composition further includes a flavoring agent preferably chosen from: essential oils, synthetic mixtures or flavors, including but not limited to oils derived from plants and fruits such as citrus oil, fruit essences, peppermint oil, mint oil, other mint oils, clove oils, sugar oil, aniseed and similar, aromatic oils with germ-killing properties such as menthol, eucalyptus, thymol, spices such as cocoa powder and cinnamon powder, as flavoring agents and their combinations.

According to a further form of realization of the invention, this composition further includes a sweetening agent preferably chosen from: sweeteners containing saccharides, including, but not limited to, sucrose, dextrose, maltose, dextrin, fructose, laevulose, galactose, corn syrup solids and the like, alone or in any combination. Sugar-free sweeteners include, but are not limited to: sugar alcohols such as sorbitol, mannitol, xylitol, isomalt, hydrolysates of hydrogenated starch, maltitol and the like, and combinations thereof.

A further aspect of this invention concerns the use of the composition as described above for the preparation of an edible film. In other words, a further aspect of the present invention concerns the composition of the invention as described above formulated as a film or edible film.

Preferably the film/edible film is obtained/obtainable by the process described below.

In this context, edible film means a thin layer of material that can be consumed, used to cover food and act as a barrier between food and the surrounding environment.

This film shall comprise at least one layer of a thickness of approximately 50 to 75 μm, preferably 60 to 70 μm.

Preferably the film is a single-layer or multi-layer.

Alternatively, the film of the invention may be a biodegradable polylaminate.

A further aspect of the present invention concerns a method for the preparation of an edible film that includes the phases of:

(I) prepare a solution (solution I) including the mucous secretion, preferably the snail slime, gelling agent and plasticizer as described above; and

(II) prepare a solution (solution II) including the crosslinking agent and the adjuvant of the crosslinker as described above.

The process then involves a step where Solution II is added to Solution I.

According to a preferred aspect of the invention, solution I includes:
0.5-3%, preferably about 1% of gelling agent as described above;
0.2-1%, preferably 0.3-0.8% of plasticizer as described above;
0.5 to 5%, preferably about 1% of mucous secretion of gastropods, preferably snail slime as described above percentage understood as dry extract of mucous secretion/slime.

Preferably solution I is prepared at a temperature of about 60-80, more preferably about 70° C.

According to a preferred aspect of the invention, solution II includes:
0.05-0.8%, preferably 0.1-0.5% of crosslinking agent as described above;
eventually 0.4-2%, preferably 0.6-1.5% of crosslinking adjuvant.

Preferably solution II is added to solution I at a temperature between 50 and 60° C.

Preferably, the composition is dehydrated through at least one passage in a stove and/or in a temperature-controlled chamber in order to obtain a composition suitable for use in the food industry.

Optionally, if the ingredients of the composition are not completely dissolved, it is possible to keep the composition in agitation until the ingredients are completely dissolved and/or sonicate the solution to facilitate their dissolution.

The solution is transferred to a container, preferably flat and eventually characterized by raised edges for a thickness/height of about 0.3-0.5 cm.

After treatment in an oven, preferably for about 8-12 hours at a temperature of about 50-60° C., the film obtained is cooled, preferably at room temperature before extracting it. Said film comprises at least one layer of a thickness of approximately 50 to 75 μm, preferably 60 to 70 μm, more preferably 64 to 5 μM. Alternatively, the composition as described above may be formulated in the form of a food-grade gel, liquid solution, powder, granules. Alternatively, the composition as described above may be formulated as a spray.

These formulations are for application on food products or in the manufacture of pet hygiene products or as natural detergents.

A further aspect of this invention concerns the use of the composition as described above, preferably formulated as a film/edible film, for food use, preferably for the storage, preservation or storage of foodstuff/food products.

In this context, food should preferably be considered as perishable food, i.e. pre-packaged food products, preferably those intended as such for the consumer, with a shelf-life of preferably less than approximately 90 days, and/or bulk food products and/or food wrapped in a protective wrapping, preferably intended for sale, preferably after splitting and not undergoing any treatment which would be expected to result in bulk storage for a period preferably exceeding approximately 3 months, preferably milk and milk products, fresh meat and food preparations, fishery products, preferably fresh, egg products, fresh or pasteurised, fruit and vegetables or fresh pasta, preferably with filling.

Preferably the average life of these foods is a few days, preferably 2 or 3 days.

In fact, the authors of the present invention have found that by using the composition of the present invention, in particular as a film/edible film, it is possible to increase the average life (shelf life) of foods, in particular, thanks to the antimicrobial and/or antioxidant properties of the mucous secretion of gastropods, preferably snail slime, which are preserved and/or enhanced by the composition described above.

Advantageously with the composition of the present invention, formulated as a film, an extension of the shelf-life of not less than 2 days with respect to the expiry date has been observed, in particular for poultry and beef.

Therefore, the composition of the invention, preferably as a film/edible film, is ideal for food packaging.

Melting or application of the composition on a carrier material and/or food can be performed using any conventional coating technique. Examples of coating techniques include spraying, dipping, powder coating, knife on plate, roll on roll, reverse roller, slot extrusion and various extrusion techniques. A pump or air pressure can be used for slot food molds or other extrusion processes. The thickness of the film can be controlled by applying the desired amount of the solution to the substrate.

As previously mentioned, the film/edible film comprises at least one layer of a thickness of approximately 50-75 μm, preferably 60-70 μm. However, no special limits are placed on the thickness of the film layer.

The edible films of this invention are suitable for the preparation of products intended for food applications as well as for direct consumption. Preferably, they can be used to add flavours or other ingredients to soups, drinks and other edible consumer products and prepared commercially. Alternatively, citrus-flavored films can be provided that are added to the water by a consumer to provide flavoured water. A wide variety of flavours and foods and drinks to which flavored films can be added can be imagined.

### EXAMPLE

### Preparation of the Film

The ingredients for the preparation of the product are:

### Sodium Alginate

Alginate is a linear block copolymer with a wide range of food uses, consisting of units of mannuronic acid and glucoronic acid in varying proportions. Alginate is able to generate thermostable and irreversible gels with “egg-box” network in the presence of bivalent ions. These are able to dilegate to the polymer, preferably to the glucoronic units, to generate a compact and orderly reticulated structure and giving the material the peculiarity of holding and gradually releasing the additives incorporated within it.

### Glycerol

Used as a plasticizer. Crosslinking is obviously essential to improve many of the qualities of the polymeric film, but has as a drawback the fact that it makes the production process difficult, the workability of the material and some final mechanical properties. By means of plasticising agents, suitable compromises can be made between the parts. A plasticizer is an additive that increases the plasticity of the material into which it is inserted, acting as a lubricating fluid.

### Mucous Secretion of Helix Aspersa

The active ingredients contained in the mucous secretion of Helix aspersa form the core of the film produced. Appropriately inserted into the polymer lattice, they are gradually released on the product on which it is desired to act. For this reason, the secretions purchased from various suppliers were selected and the best characteristics that must be present were defined: pH=2.70±0.2; dry residue>3%; density≥1.01; good antioxidant power determined by testing with DPPH. CaCO₃ and GDL (D-(+)-Gluconic acid δ-lactone)

They are used as crosslinking agents and crosslinking promoters. The CaCO₃ has the function of releasing Ca²⁺ ions in solution, with the help of the GDL. Ca²⁺ ions promote crosslinking, thereby increasing mechanical resistance and at the same time decreasing the release over time of the principles of mucous secretion.

### Film Preparation

In the production process of the film, mucous secretion of Helix aspersa is indispensable and cannot be replaced. Sodium alginate can be substituted with pectin or agar agar; glycerol with polyethylene glycols; GDL can be omitted; CaCO₃ can be substituted by another source of Ca²⁺ ions such as calcium citrate, CaCl₂, calcium gluconate or CaSO₄.

### Prepare the Following Solutions

The first 1% solution of alginate is prepared: the water is heated to 70° C. During this phase it is advisable to be careful not to shake too much as there is a risk that bubbles will form which are very difficult to eliminate a posteriori; however, this salt does not dissolve very well, so its dissolution can be helped by using a large magnet and eventually by acting manually (e.g. with a specil) at least as soon as it is added. Since alginate at 70° C. tends to “caramelize”, it is also advisable to carry out this operation in a water bath.

When the alginate solution is ready, a volume of mucous secretion of Helix aspersa can be added such that the resulting solution contains 1% of dry extract of secretion, in which glycerol has been dissolved in quantities by weight equal to 50% of the alginate.

The second solution is prepared at 1% by weight of GDL in a volume of distilled water equal to half that used to dissolve the alginate, in which is added a quantity of CaCO₃ equal to 9% by weight compared to the alginate. The second solution is added to the first one, which is at 70° C., the temperature is lowered to 55° C. and stirring is maintained for 90 minutes.

Then the preparation is poured into a suitable flat container with raised edges. The obtained solution is poured until a height of about 0.43 cm is obtained and place the container in an oven at 55° C. for 10 hours.

Criticality: care should be taken not to create bubbles. When using a pipette, it is advisable not to empty the tip of the pipette. Once the solution is in the container, if any bubbles are located they can easily be eliminated using a Pasteur pipette.

The solution left on the bottom of the preparation container, and therefore close to the magnet, is generally rich in bubbles, as a result of the stirring process, and therefore not usable.

Once the period in the stove is over, the film must be cooled to room temperature before it is extracted.

In the tests carried out, the film obtained showed a thickness of 64±5 μM.

With respect to the quantities reported, films can be prepared starting from an alginate solution between 0.80 and 1.30% w/v and using the other ingredients in the following ranges (% expressed in w/w with respect to alginate): glycerol: 20-60%; CaCO₃ 8-10%; GDL 0-60%. % of dry residue of Helix aspersa mucosa secretion: 0.8-2.0% in the resulting solution. In solution 1, together with the secretion of Helix aspersa, it is possible to add dry extracts of natural origin or oleolites in a percentage between 50% and 150% of the value of dry residue of mucous secretion.

### Microbiological Tests

Samples of beef and poultry meat were used as a matrix for the subsequent tests. For the quantification of aerobic colonies associated with meat matrices, the method described in the UNI EN ISO 4833:2004 standard has been applied. 30 g of turkey/bovine meat were sampled from different locations and diluted 1/10 in buffer peptone water (BPVV) broth to obtain a broth culture. After homogenization, serial dilutions were prepared in base 10, from 10⁻¹ to 10⁻⁷. The snail slime (Helix aspersa) was then prepared by diluting it at different concentrations in sterile PBS. The same volume of the inhibitor (snail slime) and the broth were put into contact in a tube and incubated at 30° C. for 4 hours.

During incubation, 100 μL of the negative control (dilutions obtained from broth culture without snail slime) were sown on double plates of Triptic soy agar TSA, which were incubated at 30° C. for 72 h as required by the standard.

After 4 hours of contact, 100 μL of broth, with the addition of Helix aspersa slime, was spatulaed on double TSA medium and incubated as previously described for the control plates. After 72 h the 2 dishes with the lowest number of accounting colonies between 10 and 300 were taken into account to calculate the value of CFU/ml. The presence of a difference between the values of CFU/ml found respectively in the control and in the sample treated with snail slime was expressed as logarithmic difference (ΔLog).

Helix aspersa slime was tested at the following concentrations: 1:2, 1:4, 1:6, 1:10 and each condition was repeated 5 times. At a concentration of 1:6, the inhibitory capacity of snail slime was evaluated both on freshly packaged meat products and on expired products, and a test was also carried out with prolonged contact between broth and inhibitory at 30° C. for 72 hours. At concentration 1:10 the contact time was extended up to 6.5 h.

The inhibitory capacity of the film containing the snail slime with respect to the microbial component of the meat was also confirmed by tests performed according to the Kirby Bauer method. This technique involves placing the film in the centre of a Petri dish on which the broth obtained from the meat has previously been spread. The results showed the absence of growth of microorganisms around the film containing the slime (inhibition halo), while in the control plate the microbial growth was also evident behind the film without snail slime (absence of inhibition halo).

### Testing the Effectiveness of the Helix Aspersa Secretion Film: Shelf-Life Evaluation at 4° C.

The edible films, placed on the two inner sides of sterile Petri dishes, with snail slime (at a concentration of 1:4 and 1:6) and without slime, were then used in direct contact with meat matrices (slices of turkey and hamburgers of adult cattle). The meat, which had a label with an expiry date the day after the test was carried out, was placed inside the plates containing the films (with Helix aspersa slime and without slime) and kept in refrigeration conditions for 24-48-72 hours.

After 24 hours (the day of expiry), the meat contained in two dishes (with and without snail slime) was sampled according to UNI EN ISO 4833:2004 standard. The procedure described in the previous paragraph was then followed. The same protocol was used on fresh meat that remained in contact with films with and without slimes for at least 72 h at 4° C.

The results of the microbial count performed on the control sample (meat in contact with slime-free film) and on the sample (meat in contact with film containing snail slime) showed a logarithmic difference (ΔLog) of 2-3 Logs consistent with an extension of the shelf life of the product of at least 2 days.

1. A composition comprising at least one mucous secretion of gastropods and at least one additional ingredient selected from: a gelling agent, a plasticising agent, a crosslinking agent and eventually a crosslinking adjuvant wherein said mucous secretion is present in a concentration as a dry residue in a percentage (%) comprised between 0.8 and 2% w/w of the weight of the total mass of the composition.

2. The composition according to claim 1, wherein said gelling agent is selected from: alginates, propylene glycol, pectin, and natural gelling agents, carboxymethylcellulose, methylcellulose, hydroxypropylmethylcellulose, guar gum, carob gums, xanthan gums, hydrolysed gums, carrageenan, tamarind, konjac, arabinogalactan, arabinogalactan from larch, beta-glucan, levan, pullulan, curd, chitosan, arabic gum, native starches, waxy maize starch, potatoes, tapioca, rice and wheat starch, modified starches, maltodextrins, albumin, gelatin, casein, casein salts, whey, wheat gluten, zein, soy protein, polyvinylpyrrolidone, methacrylate copolymers and carboxyl-vinyl copolymers alone and their combinations; said agent gelling being present in a concentration comprised between 0.2 and 3% w/v of the solution.

3. The composition according to claim 1, wherein said plasticising agent is selected from: glycerol, hydrogenated and partially hydrogenated vegetable oil, cocoa butter, sorbitol and other polyols, glycerine, polyethylene glycol, propylene glycol, inverted sugars, corn syrup, lecithin, hydrogenated lecithin, mono-, di- and triglycerides, acetylated monoglycerides, stearic, palmitic, oleic and linoleic acids and their combinations; said plasticizing agent being present in a concentration comprised between 20 and 60% w/w compared to the weight of the gelling agent.

4. The composition according to claim 1, wherein said crosslinking agent is selected from: calcium carbonate, calcium chloride, calcium citrate, calcium gluconate, calcium phosphate, tri-calcium phosphate, calcium sulphate, microcrystalline cellulose, cellulose polymers, magnesium, ground limestone, silicates, clay, talc, titanium dioxide, monocalcium phosphate, others as mass fillers and their combinations; said crosslinker being present in a concentration comprised between 8-10% w/w compared to the weight of the gelling agent.

5. The composition according to claim 11, wherein said snail slime is from the species Helix aspersa.

6. The composition according to claim 11, wherein said snail slime is characterized by:
a pH comprised between 2 and 4; and/or
a dry residue of greater than or equal to 3%; and/or
a density greater than 1.01 g/cm³; and/or
a good antioxidant power.

7. The composition according to claim 11, wherein said snail slime comprises:
glycolic acid, preferably in quantities ranging from 50 mg/kg to 200 mg/kg;
and/or allantoin, preferably in quantities ranging from 50 mg/kg to 200 mg/kg; and/or
antiprotease, preferably in quantities ranging from 1.0 mU/L to 1.8 mU/L; and/or
hydroxyproline, preferably in quantities ranging from 0.5% p/p, to 1.5% p/p; and/or
collagen, preferably in quantities ranging from 0.05% to 0.5% w/w;
lactic acid, preferably in quantities ranging from 10 mg/kg to 100 mg/kg; and/or
mucopolysaccharides, preferably sulphurised GAGs and/or non-sulphurised GAGs; and/or
at least one vitamin chosen from: vitamins A, C, E, B1 and B6; and/or
free amino acids.

8. The composition according to claim 1 comprising an additional crosslinking adjuvant.

9. The composition according to claim 1 any of the claims 1-8 formulated as film.

10. Method of preserving or storing food, with the composition according to claim 1, said food being characterized by a shelf-life of 2 or 3 days; and said foods being selected from: vegetables, fruits, baked goods, fresh pasta, refrigerated ready meals, fresh cheeses, fish, meat and their derivatives, said method comprising:
applying said composition to said food.

11. The composition according to claim 1, wherein said at least one mucous secretion of gastropods is snail slime.

12. The composition according to claim 1, wherein said gelling agent is present in a concentration comprised between 0.5 and 2% w/v of the solution.

13. The composition according to claim 1, wherein said gelling agent is present in a concentration comprised between 0.8 and 1.3% w/v of the solution.

14. The composition according to claim 6 wherein said snail slime is characterized by:
a pH comprised between 2.5 and 2.9.

15. The composition according to 7 wherein said snail slime comprises:
glycolic acid, in quantities ranging from 50 mg/kg to 200 mg/kg;
and/or allantoin, in quantities ranging from 50 mg/kg to 200 mg/kg; and/or
antiprotease, in quantities ranging from 1.0 mU/L to 1.8 mU/L; and/or
hydroxyproline, in quantities ranging from 0.5% p/p, to 1.5% p/p; and/or
collagen, in quantities ranging from 0.05% to 0.5% w/w;
lactic acid, in quantities ranging from 10 mg/kg to 100 mg/kg; and/or
sulphurised GAGs and/or non-sulphurised GAGs.

16. The composition according to claim 8, wherein said an additional crosslinking adjuvant, is selected from: δ-D-gluconolactone, adipic acid, citric acid, gluconic acetic acid, tartaric acid, succinic acid, lactic acid and malic acid, wherein the adjuvant is present in a concentration comprised between 0-60% w/w compared to the weight of the gelling agent.

17. The composition according to claim 9 wherein said film is characterized by at least one layer of a thickness of about 50-75 μm.

18. The composition according to claim 9, wherein said film is characterized by at least one layer of a thickness of about 60-70 μm.
